(19) United States
(12) Patent Application Publication
(10) Pub. No.: US 2025/0060461 A1
(43) Pub. Date: Feb. 20, 2025

(54) LASER DISTANCE-MEASURING RECEIVING CHIP AND ITS CONFIGURATION METHOD IN THE COURSE OF CALIBRATION

(71) Applicant: SHENZHEN ADAPS PHOTONICS TECHNOLOGY CO., LTD., Shenzhen (CN)

(72) Inventors: Honggang LI, Shenzhen (CN); Jiajie TANG, Shenzhen (CN); Chao ZHANG, Shenzhen (CN)

(21) Appl. No.: 18/806,492

(22) Filed: Aug. 15, 2024

(30) Foreign Application Priority Data
Aug. 16, 2023 (CN) 202311032628.5

(51) Int. Cl. G01S 7/4863; G01S 7/481; G01S 7/486; G01S 7/4865; G01S 7/497; G01S 17/10

(52) U.S. Cl. CPC G01S 7/4863; G01S 7/4816; G01S 7/4865; G01S 7/4868; G01S 7/497; G01S 17/10

(57) ABSTRACT

The invention discloses a laser distance-measuring receiving chip and its configuration method. According to the SPAD open position stored in the ROI configuration register, control the corresponding SPAD open, and according to the value of the pixel selection signal and the value of the TDC selection signal to control the switch gating in the bus matrix, the open SPAD data through the corresponding TDC output. Since the light bar is divided into multiple sub-light bars, each sub-light bar can be independently configured to open the position, so that the SPAD ROI area can be flexibly configured according to the actual falling point of the spot. After the SPAD is opened, the switch gating in the bus matrix can be controlled according to the value of the pixel selection signal and the value of the TDC selection signal, and the open SPAD data is output to realize the flexible opening of the SPAD ROI area, so that the RX can receive the information of the TX more accurately and realize the distance measurement.

### CROSS-REFERENCES TO RELATED APPLICATIONS

The present application claims priority to Chinese Patent Application No. CN2023110326285, filed on Aug. 16, 2023, and the application is commonly owned and incorporated by reference herein for all purposes.

### FIELD

The present invention relates generally to the field of laser distance-measuring, in particular to a laser distance-measuring receiving chip and a configuration method thereof in the calibration process.

### BACKGROUND

Based on the principle of Direct-Time of flight (D-TOF), solid-state laser radar uses Single Photon Avalod Diode (SPAD) technology to achieve ranging.

In an ideal state, the multiple pixel positions opened by the receiving end (RX) through rolling each time align precisely with the light-emitting zones of the laser transmitting end (TX), that is, when a certain zone of TX emits light, the laser light bar that falls on the receiving end (RX) should be a straight line, and the sequence of activated pixels should also form a continuous line. Generally, the connection of multiple pixels is completely coincident with the shape and position of the laser light bar, so that the RX end can detect the light bar very efficiently.

However, in the actual scene, due to the process or the device itself, the laser light bar is not a strict straight line on RX, and may be an irregular line (oblique line, curve), and considering the assembly error of the device, the laser light bar may generate upper, lower, left and right offsets, while multiple pixels opened by the conventional method are still connected as a straight line and the position is fixed, so that the line cannot be completely overlapped with the laser light bar, leading to the failure of the RX end to fully detect the light bar and accurately receive the information of TX, so the distance measurement cannot be accurately realized.

### SUMMARY

Embodiments of the present invention that are described herein below provide a laser distance-measuring receiving chip and its configuration method in the course of calibration, so as to configure SPAD and open the SPAD ROI area flexibly.

In one embodiment, the present disclosure a laser ranging receiving chip, includes, a SPAD array and a TDC array, wherein the number of the TDC unit is less than the number of the SPAD, bus matrix having a plurality of buses for connecting the SPAD in the SPAD array with the TDC unit in the TDC array through a plurality of switches, ROI configuration register, for storing configuration information, wherein the configuration information further includes the number of segments of the light bar divided into sub light bars, the position of the pixel where each segment of the sub light bar is located, the number of SPADs contained in one pixel, the value of a pixel selection signal and the value of the TDC selection signal, and the configuration information is configured by the chip during the calibration process, and SPAD and bus routing controller, for according to the position of the pixel where each segment of the sub light bar is located and the number of SPADs contained in one pixel, determining the position and controlling the corresponding SPAD to open; and is configured to transmit the value of the pixel selection signal and the value of the TDC selection signal to the bus matrix so as to control the switch gating in the bus matrix, and output the opened SPAD data through the corresponding TDC unit.

In an alternative embodiment, the configuration information further includes position information of each SPAD contained in each pixel.

In an alternative embodiment, the configuration information further includes the segment number of each segment of the sub light bar.

In an alternative embodiment, when a plurality of rows of light bars are obtained during the calibration process, the configuration information includes the row number of the plurality of rows of light bars.

In an alternative embodiment, the configuration information further includes, the value of k, where k is the number of rows of SPAD opened in a pixel, and is an integer greater than or equal to 1 and less than or equal to N. One pixel comprises N*N SPAD, and has k rows*N columns of SPAD units opened.

In an alternative embodiment, the configuration information further includes the segment number and row number of the sub light bar corresponding to each light bar block; The light bar block includes a plurality of segments of the sub light bar in the horizontal direction and a plurality of rows of the sub light bar in the vertical direction.

In an alternative embodiment, any one row in the SPAD array includes m SPADs, one row in the TDC array includes m/N TDC units, and one TDC unit corresponds to one opened pixel; wherein m is greater than or equal to N, and one pixel includes N*N SPAD; the bus matrix is configured to connect one TDC unit in one row of TDC units with its corresponding pixel through a plurality of switches, and the plurality of pixels which are commonly connected with one TDC unit at least comprise one same column of SPAD, and when scanning for one time, only one opened pixel is output by the TDC unit. In an alternative embodiments, the SPAD and the bus routing controller are configured to control the switch gating in the bus matrix.

Additionally, a TDC unit on a row is connected with N pixels, the SPAD and the bus routing controller are configured to control the switch gating in the bus matrix according to the value of the pixel selection signal, select one opened pixel from the N pixels, and output the data of the opened pixel from the TDC unit.

In an alternative embodiment, a column of SPAD gated in the SPAD array includes L pixels, and a column of TDC units in the TDC array includes L TDC units; The bus matrix is configured to connect the SPAD in the SPAD array with the TDC unit in the TDC array and to connect any one pixel of L pixels on a column to any one TDC unit of L TDC units on a column.

In an alternative embodiment, the SPAD and the bus routing controller are configured to control the switch gating in the bus matrix: a pixel on a column is connected with L TDC units, the SPAD and the bus routing controller are configured to control the switch gating in the bus matrix according to the value of the TDC selection signal, select one TDC unit from the L TDC, and output the data of the pixel from the gated TDC unit.

There is also provided, in accordance with an embodiment of invention, a configuration method of a laser ranging receiving chip during the calibration process, which includes, obtaining the position of the light bar in the SPAD array; according to the position of the light bar and the preset precision, setting the number of the segments averagely divided by the light bar; according to the segment number of the light bar and the position of the light bar, configuring the position of the pixel where each segment of sub light bar is located.

In an alternative embodiments, after the step of configuring the position of the pixel where each segment of the sub light bar is located, the method further includes, configuring the number of SPAD contained in one pixel; according to the position of the pixel where each segment of said sub light bar is located and the number of SPAD contained in one pixel, configuring the position of each starting SPAD in the pixel where each segment of said sub light bar is located.

In an alternative embodiments, after configuring the position of each SPAD in the pixel where each segment of the sub light bar is located, the method further includes, the value of the pixel selection signal and the value of the TDC selection signal are configured such that each on-SPAD data can be output through the corresponding TDC unit.

In an alternative embodiments, when a plurality of rows of pixels need to be opened by scanning each time, the configuration method specifically includes, configuring each scanning to open L rows of pixels; obtaining the position of L light bars in the SPAD array; according to the position and the preset precision of the L light bars, setting the average divided segment number of each light bar; according to the segment number of each light bar and the position of each light bar, configuring the position of the pixel where each sub light bar is located.

In an alternative embodiments, when it is necessary to control the amount of light entering, the configuration method further includes, configuring the row number opened by SPAD in one pixel.

In an alternative embodiments, when the two-dimensional scanning is required each time, the step of configuring the position of the pixel where each segment of the sub light bar is located specifically includes, configuring the segment number and row number of the sub light bar corresponding to each light bar block; The light bar block includes a plurality of the sub light bars in the horizontal direction and a plurality of rows of the sub light bars in the vertical direction.

The invention provides a laser distance-measuring and receiving chip, in the chip, the SPAD in the SPAD array and the TDC unit in the TDC array are connected together through a bus matrix, when the SPAD needs to be opened, SPAD and bus routing controller according to the position of SPAD opening stored in ROI configuration register, controlling the corresponding SPAD opening and sending the value of pixel selection signal and the value of TDC selection signal stored in ROI configuration register to the bus matrix, therefore, the switch gating in the bus matrix is controlled and the opened SPAD data is output by the corresponding TDC unit. In comparison with the previous TX that a certain sub-area emits light, the light bar falling on RX is a straight line, and falls in the area of the appointed position, firstly, in the laser distance measuring receiving chip provided by the invention, the light bar is divided into multiple segments of sub light bars, each segment of sub light bar can be independently configured with an opening position, It realizes the flexible configuration of SPAD so that the SPAD ROI area can be configured according to the factual falling point condition of the light spot; and after the SPAD is turned on, the value of the signal can be selected according to the pixel, the value of the TDC selection signal controls the switch gating in the bus matrix, outputs the opened SPAD data, realizes the flexible opening of the SPAD ROI area, enables the RX to accurately receive the TX information, and realizes the distance measurement; secondly, the flexible opening of the SPAD ROI area can reduce the requirements on the TX and RX processes and the precision of the assembly of the two devices, and greatly improve the yield of the product; Then, in the case where the SPAD array is small, the SPAD and the TDC unit can be one-to-one correspondence, and in the present invention, due to the presence of the pixel selection signal and the TDC selection signal, in the case where the SPAD array is large and the number of the TDC units is limited, the switch gating in the bus matrix can be controlled by the value of the pixel selection signal and the value of the TDC selection signal so as to output the SPAD signal by the corresponding TDC unit, which realizes the multiplexing of the TDC unit, greatly reduces the number of the TDC unit and saves the cost.

### BRIEF DESCRIPTION OF THE DRAWINGS

The disclosure will be readily understood by the following detailed description in conjunction with the accompanying drawings, wherein like reference numerals designate like structural elements.

FIG. 1 is a schematic diagram of a laser distance-measuring receiving chip according to an embodiment of the present invention.

FIG. 2 is a schematic diagram of a linear ROI according to an embodiment of the invention.

FIG. 3 is a schematic diagram of a 3*3 binning SPAD combined scene according to an embodiment of the present invention.

FIG. 4 is a schematic diagram of an oblique ROI according to an embodiment of the present invention.

FIG. 5 is a schematic diagram of a curve-shaped ROI according to an embodiment of the present invention.

FIG. 6 is a schematic diagram of a single-rolling multi-pixel according to an embodiment of the present invention.

FIG. 7 is a schematic diagram of a linear light bar according to an embodiment of the present invention.

FIG. 8 is a schematic diagram of opening three rows of SPAD to control light input according to an embodiment of the present invention.

FIG. 9 is a schematic diagram of opening two rows of SPAD to control light input according to an embodiment of the present invention.

FIG. 10 is a schematic diagram of opening one row of SPAD to control light input according to an embodiment of the present invention.

FIG. 11 is a schematic diagram of a one-dimensional scanning model when the SPAD array is 767*575 according to an embodiment of the present invention.

FIG. 12 is a schematic diagram of a two-dimensional scanning model when the SPAD array is 767*575 according to an embodiment of the present invention.

FIG. 13 is a schematic diagram of one-dimensional scanning according to an embodiment of the present invention.

FIG. 14 is a schematic diagram of a two-dimensional scanning according to an embodiment of the invention.

FIG. 15 is a circuit diagram of a 3*3 binning SPAD according to an embodiment of the present invention.

FIG. 16 is a schematic diagram of a minimum unit of a 3*3 binning SPAD circuit according to an embodiment of the present invention.

FIG. 17 is a schematic diagram of a 3*3 binning which supports at most four rows of pixels to be turned on at the same time according to an embodiment of the present invention.

FIG. 18 is a schematic diagram of a minimum unit of a circuit when 3*3 binning and at most supporting 4 rows of pixels to be turned on at the same time according to an embodiment of the present invention.

FIG. 19 is a schematic diagram of a 3*3 binning, 30*48 SPAD array supporting four rows of pixels at the same time and corresponding TDC according to an embodiment of the present invention.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The core of the invention is to provide a laser distance-measuring receiving chip and a configuration method thereof in the calibration process for realizing the flexible configuration of SPAD and the flexible opening of the SPAD ROI area. For example, the term “ROI” refers to a specific area or portion of the SPAD array that is actively monitored or targeted for signal processing during laser distance measurement. The ROI may be the subset of the SPAD array where light signals, such as those reflected from a target object, are expected to be detected and processed by the device.

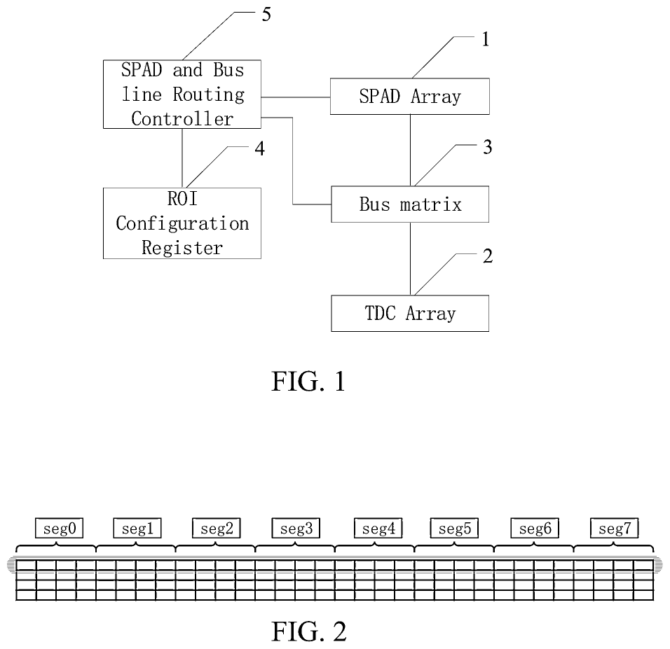

In order to enable those skilled in the art to better understand the solutions of the present invention, the present invention will be further described in detail below with reference to the accompanying drawings and specific embodiments. FIG. 1 is a schematic diagram of a laser distance-measuring receiving chip according to an embodiment of the present invention, as shown in FIG. 1, the laser distance-measuring receiving chip comprises, SPAD array 1 and TDC array 2, the number of TDC unit is less than the number of SPAD; bus matrix 3: comprising a plurality of buses for connecting the SPAD in the SPAD array 1 with the TDC unit in the TDC array 2 through a plurality of switches; ROI configuration register 4 for storing the configuration information, the configuration information comprises the segment number of the light bar divided into sub-light bars, the position of the pixel of each sub-light bar, the number of SPAD contained in one pixel, the value of the pixel selection signal and the value of the TDC selection signal, the configuration information is configured by the chip in the calibration process; The SPAD and the bus routing controller 5: for according to the position of the pixel where each segment of sub-light bar is located and the number of SPAD contained in one pixel, determining the position of SPAD opening, controlling the corresponding SPAD opening; and for sending the value of the pixel selection signal and the value of the TDC selection signal to the bus matrix 3, so as to control the switch gating in the bus matrix 3, the opened SPAD data is output through the corresponding TDC unit. For example, the term “bus matrix” refers to an interconnect architecture used in integrated circuits to enable flexible, high-speed communication among multiple subsystems within a chip. A bus matrix may include a grid-like structure of buses and switches that route data and control signals between various components. The bus matrix may support parallel data transfers and can handle multiple data streams simultaneously, improving overall system performance and scalability.

For the number of SPAD in the SPAD array, the number of TDC in the time-to-digital converter (TDC) array is not limited, and is determined according to the actual situation. TDC is used for outputting SPAD data. Each SPAD in the SPAD array can be configured individually, when the number of SPAD in the SPAD array is large, then it needs to be configured more times, taking the SPAD array as 180*300, if each SPAD is configured individually, It needs 180*300=54000 configurations. Therefore, in order to reduce the number of configurations, a plurality of SPAD can be uniformly configured as a whole, for example, in the case of 3*3 binning, 9 SPAD of one pixel can be uniformly configured as a whole. FIG. 2 is a schematic diagram of a linearly shaped ROI according to an embodiment of the present invention, as shown in FIG. 2, in the case of 3*3 binning, one cell represents one pixel, including 9 SPAD.

In order to realize the flexible configuration of the SPAD, firstly the position of the light bar is calibrated, in the calibration process, after the TX end emits the light beam, the RX end receives and records the position information of the light bar on the RX at this time; then receiving the position information of the light bar obtained in the calibration process in the ROI configuration register, dividing the light bar into multiple segments of sub-light bars to obtain the configuration information of the multiple segments of sub-light bars. The more the number of the segments of the sub-light bar is, the higher the overlapping degree of the pixel connection and the shape and position of the light bar is, the higher the detection precision is. Because each segment of sub-light bar can be independently configured with the opening position, the SPAD configuration can be more flexible, at the same time, the number of the pixels contained in each segment of sub-light bar in the horizontal direction is not limited, that is, the width of each segment of sub-light bar in the horizontal direction can be the same or different.

The configuration information comprises the number of segments of the light bar divided into sub-light bars, the position of the pixel of each sub-light bar, the number of SPAD contained in one pixel, the value of the pixel selection signal and the value of the TDC selection signal. For example, the pixels corresponding to a row of light bars are divided into K segments, and the number of the pixels included in each segment of light bars in the horizontal direction can be the same or different. In the implementation, in order to facilitate the configuration, when the light bar can be equally divided into a plurality of sub-light bars, the number of pixels contained in each sub-light bar in the horizontal direction is the same. Because the width of each segment of the sub-light bar is determined, the longitudinal coordinate of each segment of the sub-light bar is determined, when configuring the position of the sub-light bar, it only needs to configure the number of segments and the position of the longitudinal coordinate. In addition, each segment of sub-light bar may be at the position of one pixel, and may also be at the position of multiple pixels. The opening position of each segment of sub-light bar is determined by the position coordinate of the left upper angle of each sub-light bar, so the position of the pixel where each segment of sub-light bar is located is the position coordinate of the left upper angle of each pixel. When a segment of sub-light bar is only at the position of one pixel, such as at the position of A pixel, if the A pixel contains 9 SPADs, the position where the SPAD is opened can be determined to be 9 SPADs contained by the A pixel. When a segment of sub-light bar is at the position of multiple pixels, such as the position of three pixels, after determining the position coordinate of the left upper corner of each pixel, according to the number of SPAD contained in each pixel, the SPAD opening position can be determined as the SPAD corresponding to the three pixels; or after obtaining the number of the pixels included in the sub-light bar in the horizontal direction, determining the SPAD opening position according to the determined position of the left upper corner of the sub-light bar and the number of the SPAD included in each pixel. In the embodiment, the position of the left upper corner of each sub-light bar is taken as the position of the first vertex of the corresponding sub-light bar, as shown in FIG. 2, the light bar is divided into 8 segments of sub-light bars, each segment of sub-light bar comprises 4 pixels in the horizontal direction, one pixel comprises 3*3 SPAD, That is, a segment of sub-light bar comprises 36 SPADs. The position coordinates of the first vertex of each sub-light bar are (0, 0), (12, 0), (24, 0), (36, 0), (48, 0), (60, 0) (72, 0), (84, 0), the corresponding SPAD can be opened through the position of the first vertex of the sub-light bar, for example, according to (0, 0), 36 SPADs corresponding to the first sub-light bar will be opened; For example, according to (72, 0), 36 SPAD corresponding to the seventh sub-light bar will be opened. In an implementation, in order to accurately open the SPAD, the configuration information further includes: Each pixel contains position information of each SPAD. In FIG. 2, each segment of sub-light bar contains 36 SPAD, so the configuration information contains the position information of the 36 SPADs in each segment of sub-light bar. The configuration information further includes a segment number of each segment of sub-light bar. As shown in FIG. 2, in the order from left to right, the segment numbers of the eight sub-light bars divided by the light bars are sequentially marked as seg0, seg1, seg2, . . . , seg7.

When the number of SPAD is small, the SPAD can correspond to the TDC unit one by one, that is, the data of each SPAD can be output through the corresponding TDC unit, for example, the number of SPAD is 10, then one TDC unit can be configured for each SPAD, that is, the corresponding SPAD data is output through 10 TDC units, respectively. However, when the number of SPAD is large, if the number of SPAD and TDC units are to be one-to-one, the number of TDC units to be used is also large, which increases the cost, for example, the SPAD array is 180*300, that is, the number of SPAD is 54000, If the SPAD is corresponding to the TDC unit one by one, it needs 54000 TDC units, and it can be seen that the number of the TDC units required is large. Therefore, in the embodiment of the disclosure, the number of TDC units is set to be less than the number of SPAD, and under the condition that the number of TDC units is limited, the switch in the bus matrix of the TDC unit in the SPAD array and the TDC unit in the TDC array is connected by the pixel selection signal and the TDC selection signal to realize the multiplexing of the TDC unit so as to reduce the cost.

The number of bits of the pixel selection signal is determined according to the number of columns of the SPAD included in each pixel, and if 3*3 SPAD form a pixel, the number of bits of the pixel selection signal is 3 bits; When 4*4 SPAD form a pixel, the number of bits of the pixel selection signal is 4 bits. The value of the pixel selection signal and the value of the TDC selection signal are set according to the configuration information.

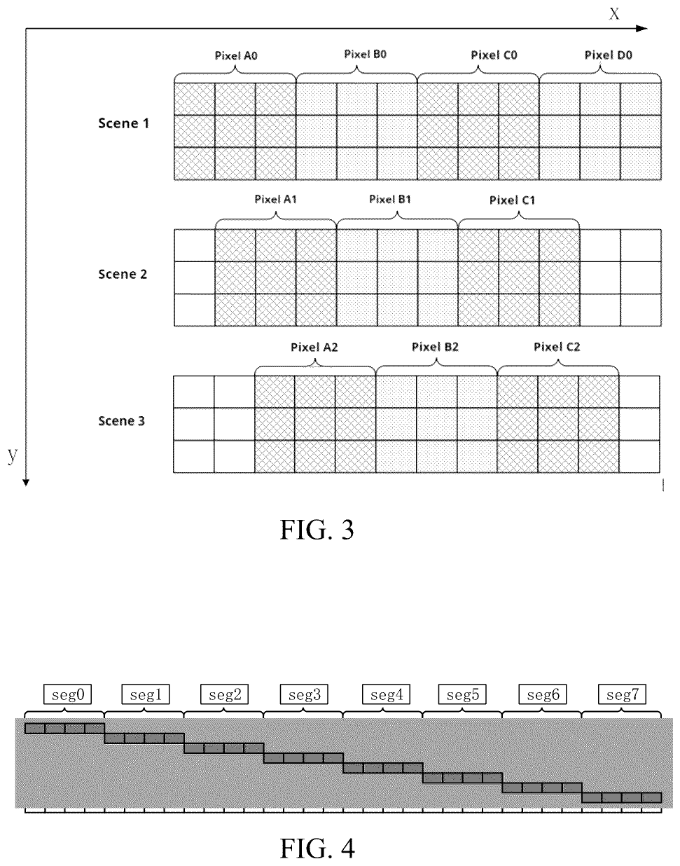

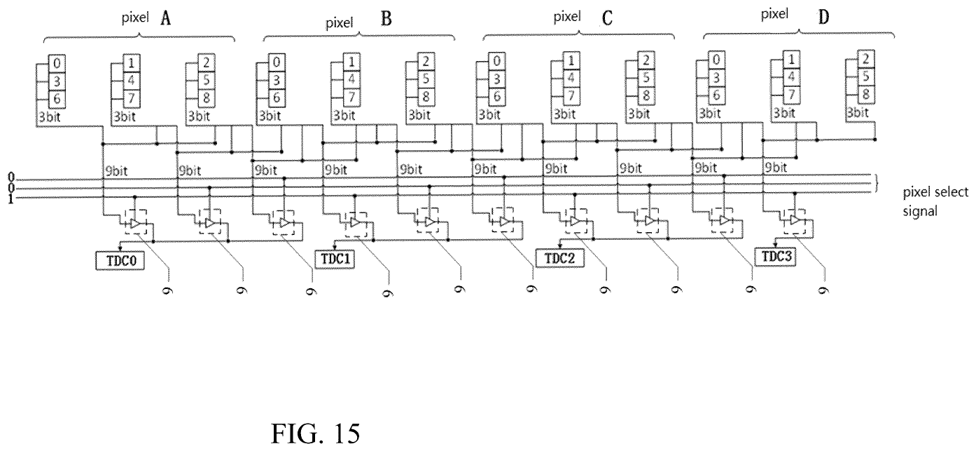

FIG. 3 is a schematic diagram of a 3*3 binning SPAD combined scene according to an embodiment of the present invention. The SPAD array comprises 3 rows*12 columns of SPAD, which will form 12/3=4 pixels, which are pixel A, pixel B, pixel C and pixel D from left to right. when calibrating, when the sub-light bar (one sub-light bar comprises 3 pixels) is located at the position of the scene 1, that is, the sub-light bar falls on the pixels A, B, C, obtaining the configuration information of the sub-light bar, the configuration information comprises the number of segments of the light bar divided into sub-light bars, the pixel position of each segment of sub-light bar, The number of SPAD contained in one pixel, the value of the pixel selection signal and the value of the TDC selection signal, and according to the configuration information, the SPAD open position is stored, and the pixel selection signal is configured to be 001, so that the data output by the TDC0 is the pixel A (see FIG. 15, corresponding to the pixel A shown in FIG. 15, the serial number is 0, 3, data of SPAD of 6, 1, 4, 7, 2, 5, 8; when calibrating, when the sub-light bar (one sub-light bar comprises 3 pixels) is located at the position of the scene 2, that is, the sub-light bar falls on the pixels A1, B1, C1 to obtain the configuration information of the sub-light bar, and is stored in the ROI configuration register, the configuration information comprises the number of segments of the light bar divided into sub-light bars, the pixel position of each segment of sub-light bar, the number of SPAD contained in one pixel, the value of the pixel selection signal and the value of the TDC selection signal, and according to the configuration information, storing the position where the SPAD is opened, and configuring the pixel selection signal as 010, so that TDC0 outputs data of pixel A1 (see FIG. 15, corresponding to data of SPAD with serial numbers of 1, 4, 7, 2, 5, 8 in pixel A and 0, 3, 6 in pixel B shown in FIG. 15); when calibrating, when the sub-light bar (one sub-light bar comprises 3 pixels) is located at the position of the scene 3, namely the sub-light bar falls on the pixels A2, B2, C2, obtaining the configuration information of the sub-light bar, and storing in the ROI configuration register, the configuration information comprises the number of segments of the light bar divided into sub-light bars, In the pixel position where each segment of sub-light bar is located, the number of SPAD contained in one pixel, the value of the pixel selection signal and the value of the TDC selection signal, and according to the configuration information, the SPAD open position is stored, and the pixel selection signal is configured to be 100, so that the TDC0 outputs the data of the pixel A2 (see FIG. 15, corresponding to the pixel A shown in FIG. 15, the serial number is 2, 5, 8 and data of SPAD with sequence number of 0, 3, 6, 1, 4, 7 in pixel B).

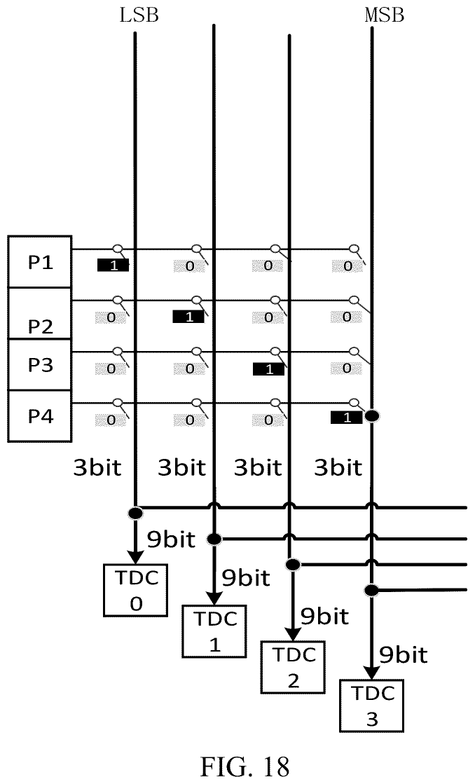

According to the value of the configuration information TDC selection signal, the opened SPAD data is output through the corresponding TDC unit, referring to FIG. 18, if 4 rows of pixels need to be opened at the same time, each pixel (P1, P2, P3, P4) in a column are corresponding to a 4-bit single heat code of TDC selection signal (T1, T2, T3, T4), namely the TDC selection signal corresponding to P1 is T1, the TDC selection signal corresponding to P2 is T2, the TDC selection signal corresponding to P3 is T3, the TDC selection signal corresponding to P4 is T4, and T1, T2, T3, T4 is 4-bit single hot code, they are completely different. The following is an example: when T1 is 0001, the pixel P1 of the first line of light bar outputs data through TDC0, at this time, T2, T3, T4 cannot be 0001; when T1 is 0010, pixel P1 outputs data through TDC1, at this time T2, T3, T4 cannot be 0010; when T1 is 0100, the pixel P1 outputs data through TDC2, at this time, T2, T3, T4 cannot be 0100; When T1 is 1000, pixel P1 outputs data through TDC3, at which time T2, T3, T4 cannot be 1000.

When T2 is 0010, the pixel P2 of the second row light bar outputs data through TDC1, at this time, T3, T4 cannot be 0001 and 0010; when T3 is 0100, the pixel P3 of the third row light bar outputs data through TDC2, at this time T4 cannot be 0001 and 0010, 0010; Therefore, when T4 is 1000, the pixel P4 of the fourth line of light bar outputs data through TDC4.

The configuration information configured by the chip in the calibration process is stored in the ROI configuration register, such as the segment number of the light bar divided into sub-light bars, the position of the pixel of each sub-light bar, the number of SPAD contained in one pixel, the value of the pixel selection signal and the value of the TDC selection signal. the SPAD and the bus routing controller determine the opening position of the SPAD according to the position of the pixel of each segment of sub-light bar and the number of the SPAD contained in one pixel, and control the opening of the corresponding SPAD; the pixel selection signal and TDC selection signal act on the switch in the bus matrix so as to control the switch gating in the bus matrix and output the opened SPAD data through the corresponding TDC unit.

The embodiment of the invention provides a laser distance-measuring and receiving chip, in which the SPAD in the SPAD array and the TDC in the TDC array are connected together through a bus matrix, when it is necessary to open the SPAD, SPAD and bus routing controller according to the position of SPAD opening stored in ROI configuration register, controlling the corresponding SPAD opening and sending the value of pixel selection signal and the value of TDC selection signal stored in ROI configuration register to the bus matrix, The switch gating in the bus matrix is controlled, and the opened SPAD data is output through the corresponding TDC.

Compared with the previous TX when a certain sub-area emits light, the light bar falling on RX is a straight line, and falls in the area of the appointed position, firstly, in the laser distance-measuring receiving chip provided by the invention, the light bar is divided into multiple segments of sub-light bars, multiple pixel opening positions can be independently configured according to each segment of sub-light bar, that is, the flexible configuration of SPAD is realized, so that the SPAD ROI area can be configured according to the actual falling point condition of the light bar; and after the SPAD is turned on, the value of the signal can be selected according to the pixel, the value of the TDC selection signal controls the switch gating in the bus matrix, and outputs the opened SPAD data through the TDC with limited number, which realizes the flexible opening of the SPAD ROI area, so that the RX can accurately receive the TX information and realize the distance measurement. secondly, the flexible opening of the SPAD ROI area can reduce the requirement of the TX and RX technology and the precision of the assembly of the two devices and greatly improve the yield of the product. In addition, under the condition that the SPAD array is small, the SPAD and TDC can be one-to-one correspondence, and in the embodiment of the invention, under the condition that the SPAD array is large, through the pixel selection signal and the TDC selection signal, the TDC number is limited, The switch gating in the bus matrix can be controlled by the value of the pixel selection signal and the value of the TDC selection signal so as to output the SPAD signal by the corresponding TDC, thereby realizing the multiplexing of the TDC, greatly reducing the number of the TDC and saving the cost. By the hardware circuit of the invention, the SPAD ROI area can be flexibly opened, and the cost advantage can be considered.

In the calibration process, the shape of a row of light bars is obtained as follows: a row of straight lines, or a row of oblique lines, or a row of curves, the first vertex positions of the multiple segments of sub-light bars in the configuration information will present corresponding shape characteristics along with the different shapes of the light bars.

The light bar is cut into multiple segments of sub-light bars, and each segment of sub-light bar can be independently configured with the opening position, so the complete light bar combined by the sub-light bars can form multiple shapes. when the shape of a row of light bars obtained in the calibration process is a straight line, the connection line of the first vertex positions of the multiple segments of sub-light bars in the configuration information is a straight line (the horizontal coordinates of each first vertex are the same or the vertical coordinates are the same), as shown in FIG. 2, The coordinates of the first vertices of the sub-light bars from seg0 to seg7 are, in order, (0, 0), (12, 0), (24, 0), (36, 0), (48, 0), (60, 0) (72, 0), (84, 0), The connecting line of the first vertex of the sub-light bar from seg0 to seg7 is a straight line. when the shape of a row of light bars obtained in the calibration process is an oblique line, the connecting line of the first vertex positions of the multiple segments of sub-light bars in the configuration information is an oblique line (the horizontal coordinates of each first vertex are different, and the longitudinal coordinates are different), FIG. 4 is a schematic diagram of an oblique ROI according to an embodiment of the present invention, as shown in FIG. 4, the coordinates of the first vertices of the sub-light bars from seg0 to seg7 are (0, 0), (12, 3), (24, 6), (36, 9), (48, 12), (60, 15), (72, 18), (84, 21), seg0 to seg7 of the sub-light bar of the first vertex of the connecting line is inclined line. Taking the oblique line ROI in FIG. 4 as an example, Table 1 is 3*3 binning its required configuration information & light bar SPAD coordinate.

TABLE 1
The configuration information needed by 3 * 3binning
under oblique ROI and SPAD coordinate of light bar

| Light bar | configuration | configuration information (Y- | SPAD position |
|---|---|---|---|
| number | information (seg_num) | axis (v_seg)) | (x, y) |
| Seg0 | 0 | 0 | (0, 0) |
| Seg1 | 1 | 1 | (12, 3) |
| Seg2 | 2 | 2 | (24, 6) |
| Seg3 | 3 | 3 | (36, 9) |
| Seg4 | 4 | 4 | (48, 12) |
| Seg5 | 5 | 5 | (60, 15) |
| Seg6 | 6 | 6 | (72, 18) |
| Seg7 | 7 | 7 | (84, 21) |

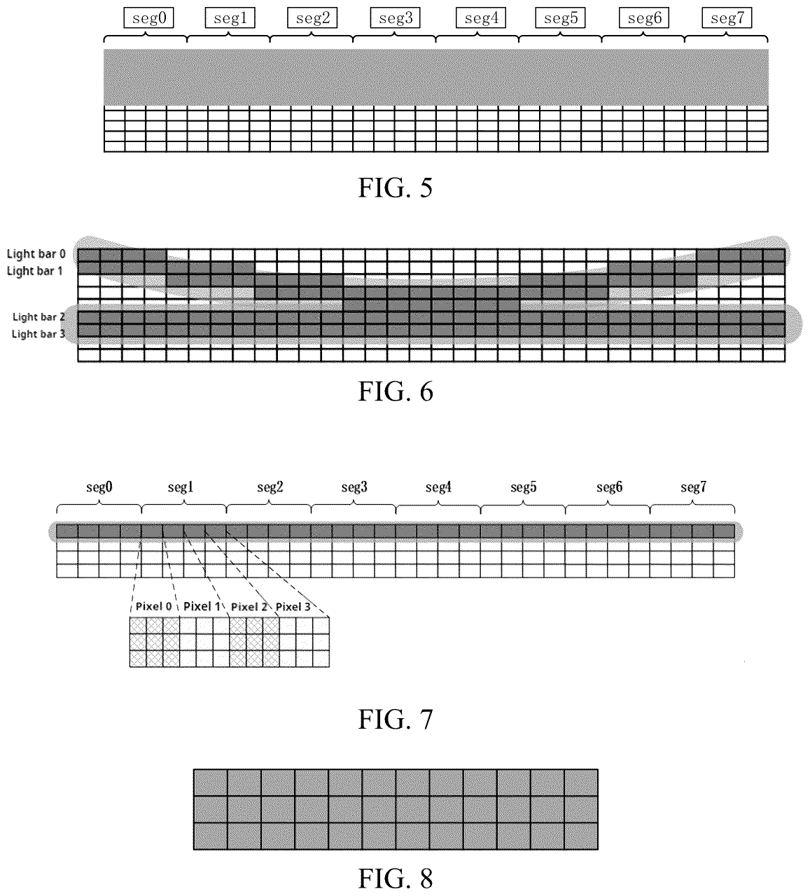

When the shape of a row of light bars obtained in the calibration process is a curve, the connection line of the first vertex positions of the multiple segments of sub-light bars in the configuration information is a curve, FIG. 5 is a schematic diagram of a curve-shaped ROI provided by the embodiment of the invention, as shown in FIG. 5, The coordinates of the first vertices of the sub-light bars from seg0 to seg7 are, in order, (0, 0), (12, 3), (24, 6), (36, 9), (48, 9), (60, 6), (72, 3), (84, 0), The connection line of the first vertex of the sub-light bar from seg0 to seg7 is a curve. Taking the oblique line ROI in FIG. 5 as an example, Table 2 is 3*3 binning its required configuration information & light bar SPAD coordinates.

TABLE 2
curve ROI, 3 * 3binning needed configuration
information & light bar SPAD coordinate

| Light bar | configuration | configuration information (Y- | SPAD position |
|---|---|---|---|
| number | information (seg_num) | axis (v_seg)) | (x, y) |
| Seg0 | 0 | 0 | (0, 0) |
| Seg1 | 1 | 1 | (12, 3) |
| Seg2 | 2 | 2 | (24, 6) |
| Seg3 | 3 | 3 | (36, 9) |
| Seg4 | 4 | 3 | (48, 9) |
| Seg5 | 5 | 2 | (60, 6) |
| Seg6 | 6 | 1 | (72, 3) |
| Seg7 | 7 | 0 | (84, 0) |

In the configuration information provided by the embodiment, the complete light bar combined by the sub-light bars can form ROI areas with various shapes, which realizes flexible configuration of the SPAD ROI area.

In the implementation, in order to expand the SPAD ROI area, when multiple rows of light bars are obtained in the calibration process, the configuration information comprises the row number of the multiple rows of light bars; The multiple rows of light bars can be non-adjacent or have different shapes.

The number of rows contained in the configuration information is not limited, and is determined according to the actual situation. In order to realize the flexible configuration of the SPAD ROI area, the multiple rows of light bars can be not adjacent or have different shapes. FIG. 6 is a schematic diagram of a single rolling and multi-opening pixel according to an embodiment of the present invention. As shown in FIG. 6, when rolling, four rows of pixels are opened at the same time, and each row of light bars can be not adjacent and have different shapes because the opening positions of the light bars can be independently configured. In FIG. 6, the light bar 0 is adjacent to the light bar 1, and both of them are curved light bars; The light bar 2 and the light bar 3 are adjacent to each other and are linear light bars. It can be seen that multiple rows of pixels can be opened by rolling for one time. In practical application, each segment of light bar can be configured according to actual need, so as to reach the field of View (FOV) range supported by the product, flexibly supporting the angular resolution, so as to realize the effect of high middle angular resolution and high two side angular resolution in practical application.

In order to realize distance measurement under different ambient light intensities, it is necessary to control the amount of incoming light, that is, increase or decrease the amount of incoming light. Therefore, the configuration information further includes: k is an integer greater than or equal to 1 and less than or equal to N, one pixel comprises N*N SPAD, and one pixel has k rows*N columns of SPAD units opened.

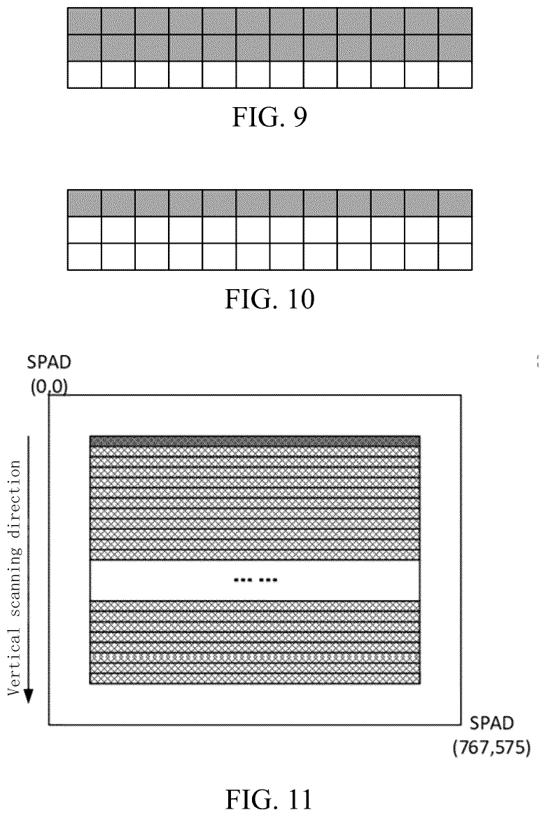

In practical application scenarios, a plurality of SPADs are coupled together as a pixel point, such as 3*3, 5*5 and so on. In this embodiment, there are still 3*3 SPAD per pixel. FIG. 7 is a schematic diagram of a linear light bar according to an embodiment of the present invention, as shown in FIG. 7, the light bar comprises 8 sub-light bars including seg0, seg1, . . . , seg7. In each sub-light bar, there are four pixels, pixel 0, pixel 1, pixel 2 and pixel 3, respectively, and in FIG. 7, 3*3 SPAD is included in each pixel by taking seg1 as an example. FIG. 8 is a schematic diagram of opening three rows of SPAD to control the amount of incoming light according to an embodiment of the present invention. FIG. 9 is a schematic diagram of opening two rows of SPAD to control light input according to an embodiment of the present invention. FIG. 10 is a schematic diagram of opening one line of SPAD to control the light input according to an embodiment of the present invention. During rolling, 1-3 rows of SPAD can be opened according to the configuration so as to realize the light inlet quantity control under different ambient light intensities.

In the configuration information provided by the embodiment, the control of the amount of incoming light is achieved by controlling the number of rows of SPAD units included in the opened pixels, and the distance measurement under different ambient light intensities can be satisfied as much as possible.

In order to increase the flexibility of the SPAD ROI area configuration, the preferred embodiment is that the configuration information further includes: sub-light bar segment number and row number corresponding to each light bar block; The light bar block comprises multiple segments of sub-light bars in the horizontal direction and multiple rows of sub-light bars in the vertical direction.

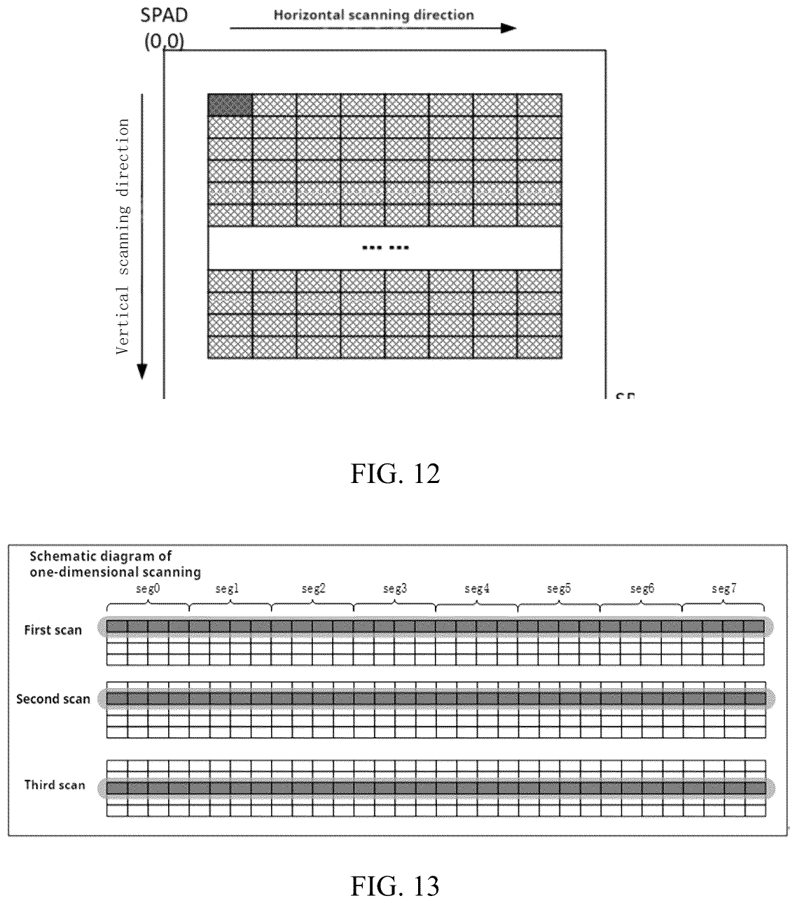

For the segment number of the sub-light bar corresponding to each light bar block, the row number is not limited, and is determined according to the actual condition. The light bar block comprises multiple segments of sub-light bars in the horizontal direction, and multiple rows of sub-light bars in the vertical direction, in order to improve the application scene of the product, in the embodiment, the mode of controlling the number of the sub-light bars opened by ROI each time supports one-dimensional scanning (1D scan) and two-dimensional scanning (2D scan), one-dimensional scanning means that the light bar is a whole in the horizontal (H) direction, and the rolling direction only moves in the vertical (V) direction; The two-dimensional scanning means that the light bar is divided into multiple blocks in the horizontal (H) direction, and the coverage of the larger visual field angle in the horizontal direction is realized by the time-sharing exposure, and the rolling direction moves in the vertical (V) direction and also in the horizontal (H) direction. FIG. 11 is a schematic diagram of a one-dimensional scanning model when the SPAD array is 767*575 according to an embodiment of the present invention. FIG. 12 is a schematic diagram of a two-dimensional scanning model when the SPAD array is 767*575 according to an embodiment of the present invention.

The specific implementation of the one-dimensional scanning and the two-dimensional scanning will be described below. Under the condition of one-dimensional scanning, when opening the light bar according to the configuration information, defaulting that each configuration information is only used for opening a segment of light bar, once complete rolling is to open all the sub-light bars, then exposing. FIG. 13 is a schematic diagram of a one-dimensional scanning according to an embodiment of the present invention, for example, the number of scanning is 3, and the one-dimensional scanning condition of only one row of pixels is displayed for each rolling. In practical application, multiple rows of pixels can be opened by rolling every time.

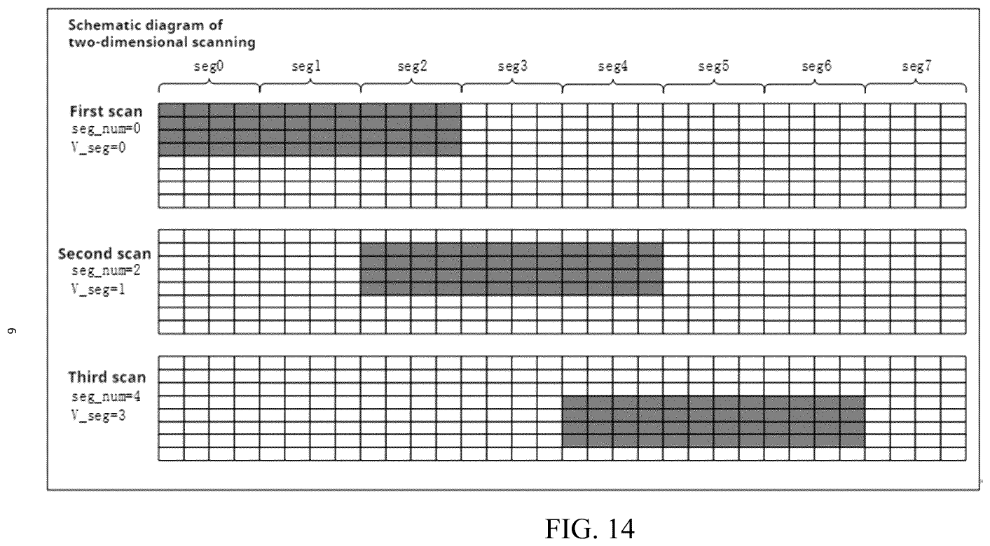

Under the condition of two-dimensional scanning, when opening the light bar according to the configuration information, each rolling only reads one configuration information, then taking the sub-light bar coordinate recorded by the configuration information as the starting point, continuously opening multiple segments of sub-light bars to the right, the number of the opened sub-light bars is controlled by ROI configuration register according to the actual application scene. FIG. 14 is a schematic diagram of a two-dimensional scanning according to an embodiment of the present invention, for example, the scanning times are three times, three segments are started each time, and four rows of pixels are opened each time.

In the configuration information provided by the embodiment, the number of segments and the number of rows of the sub-light bars in the light bar block are configured, and two forms of one-dimensional scanning and two-dimensional scanning are flexibly supported, so that the application scene of the product is greatly improved.

When the SPAD array is large and the number of TDC units is limited, in order to output the SPAD data, the preferred embodiment is that any one row in the SPAD array comprises m SPADs, one row in the TDC array comprises m/N TDC units, a TDC unit corresponding to an opened pixel; wherein m is greater than or equal to N, wherein one pixel comprises N*N SPAD;

The bus matrix is used to connect the SPAD in the SPAD array with the TDC in the TDC array through a plurality of switches, including, the bus matrix is used for connecting one TDC unit in one row of TDC units with the corresponding pixel through multiple switches, and the multiple pixels commonly connected with one TDC unit at least comprise a row of same SPAD, and when scanning for one time, only one opened pixel is output through the TDC unit.

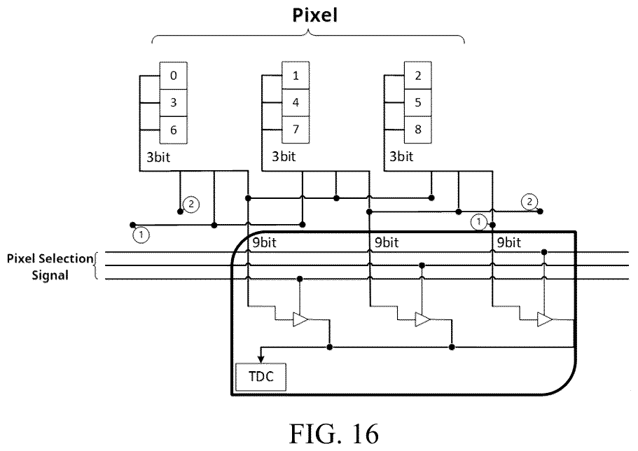

If 3*3 SPAD forms a pixel, any row in the SPAD array comprises 12 pixels, then one row in the TDC array comprises 12/3=4 TDC units. It should be noted that the pixel to be opened is the pixel to be SPAD data output, and one TDC unit corresponds to one pixel to be opened. With reference to FIG. 3, in the case of 3*3 binning, 1 column (3*1) SPAD exists: the rightmost side, the middle and the leftmost side form a scene with one pixel. Therefore, in the circuit design, it is necessary to support the pixel in three scenes, and the electrical signal can be combined and read out by the SPAD signal forming the pixel. FIG. 15 is a circuit diagram of a 3*3 binning SPAD according to an embodiment of the present invention. and a new pixel composed of two columns of SPAD in pixel A (SPAD with sequence number of 147258) and one column of SPAD in pixel B (SPAD with sequence number of 036), and a new pixel composed of one column of SPAD (SPAD with serial number of 258) in pixel A and two columns of SPAD (SPAD with serial number of 036147) in pixel B; The bus matrix combines TDC1 with pixel B, and two columns of SPAD in pixel B (SPAD with serial number of 147258) and one column of SPAD in pixel C (SPAD with serial number of 036) through switch 6 to form a new pixel, and a new pixel connection consisting of a column of SPAD (SPAD of serial number 258) in pixel B and two columns of SPAD (SPAD of serial number 036147) in pixel C. FIG. 16 is a schematic diagram of a minimum unit of a 3*3 binning SPAD circuit according to an embodiment of the present invention.

The SPAD and the bus routing controller are used to control the switch gating in the bus matrix, a TDC unit on a row is connected with N pixels, the SPAD and bus route controller are used for controlling the switch gating in the bus matrix according to the value of the pixel selection signal, selecting an opened pixel from N pixels, and outputting the data of the opened pixel from the TDC unit.

The number of sub-signals contained in the pixel selection signal and the number of columns of SPAD constituting one pixel are determined. Referring to FIG. 3 and FIG. 15, for example, 3*3 SPAD forms a pixel, the pixel selection signal PL0 is a 3-bit unique heat code, and after calibration, the pixel selection signal PL0 may be one of 001, 010 and 100. Taking TDC0 as an example, three columns of SPAD corresponding to pixel A are considered as A0 pixels in pixel A, and pixels composed of two columns of SPAD in pixel A and one column of SPAD in pixel B are considered as A1 pixels in pixel A, A pixel composed of one column of SPAD in pixel A and two columns of SPAD in pixel B is considered to be A2 pixel in pixel A, then TDC0 is respectively connected with A0, A1 and A2 pixels. For TDC0, A0 pixel, A1 pixel, A2 pixel can be output through TDC0. After the calibration, the pixel selection signal PL0 is 001, that is, after the calibration, when the pixel selection signal PL0 is 001, the SPAD and the bus route controller output the A0 pixel through the TDC0; when the pixel selection signal is 010, the SPAD and the bus route controller output the A1 pixel through the TDC0; when the pixel selection signal is 100, the SPAD and bus routing controller outputs the A2 pixel through the TDC0. For TDC1, B0 pixels, B1 pixels and B2 pixels can be output through TDC1, for TDC1, the same pixel selection signal PL0 as TDC0 can be used, or different pixel selection signals PL1 can be used. For example, when PL0 is 001, through TDC0 output is A0 pixel; When PL1 can be 100, B2 pixels are output through TDC1.

In the laser distance-measuring receiving chip provided by the embodiment, each column of SPAD will be connected with the adjacent SPAD, generating a plurality of combination modes of one pixel, selecting through the pixel selection signal, so that the data output to the TDC unit is the data of one pixel combination, The pixel can be moved by taking SPAD as step path in x direction (horizontal direction); in addition, the multiplexing of the TDC unit is realized so that the SPAD data can be output by the limited TDC unit under the condition that the SPAD array is large, the number of the TDC unit is greatly reduced, and the resource is saved.

However, in the circuit shown in FIG. 15, only a row of TDC units are connected, and therefore, only one row of pixels (3*3 binning, 3 rows of SPAD) to measure, TDC unit data after reading, can open the next row pixel, does not satisfy the actual application scene. In order to achieve the purpose that multiple rows of pixels can be opened by rolling for one time, the preferred embodiment is as follows: L pixels are arranged on a row of SPAD gated in the SPAD array, and L TDC units are arranged on a row of TDC units in the TDC array; The bus matrix is used to connect the SPAD in the SPAD array with the TDC unit in the TDC array.

The bus matrix is used for connecting any one pixel of L pixels on a column to any one TDC unit of L TDC on a column.

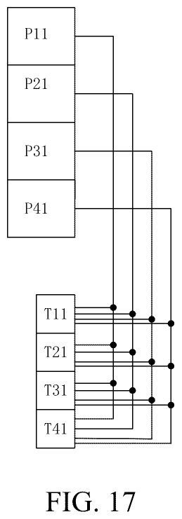

It should be noted that the SPAD array is relatively large in practice, and therefore, only the SPAD gated in the SPAD array is used in the present embodiment. If 4 rows of pixels are opened by rolling for one time, the SPAD corresponding to the 4 rows of pixels is the gated SPAD. For the pixel on one column in the SPAD array is not limited, according to the actual condition, taking 3*3 SPAD to form a pixel as an example, when one rolling is needed to open 4 rows of pixels, one column of TDC unit in the TDC array comprises 4 TDC units, as shown in FIG. 17, FIG. 17 is a schematic diagram of 3*3 binning and at most supporting 4 rows of pixels to be turned on at the same time in accordance with an embodiment of the present invention, wherein the pixel P11, the pixel P21, the pixel P31 and the pixel P41 are all connected with TDC units (T11, T21, T31, T41). FIG. 18 is a schematic diagram of a minimum unit of a circuit when 3*3 binning and at most supporting 4 rows of pixels to be turned on at the same time according to an embodiment of the present invention.

The SPAD and the bus routing controller are used to control the switch gating in the bus matrix, a pixel on a column is connected with L TDC units, SPAD and bus routing controller are used for controlling switch gating in bus matrix according to value of TDC selection signal, selecting a TDC from L TDC, and outputting data of pixel from gated TDC unit.

Taking FIG. 18 as an example, if four rows of pixels are scanned at a time, the TDC selection signal includes four TDC sub-signals (T1 corresponding to P1, T2 corresponding to P2, T3 corresponding to P3, T4 corresponding to P4), and the value of the calibrated TDC sub-signal is configured as: T1, T2, T3, T4 are 0001, 0010, 0100, 1000. when T1 is 0001, the SPAD and the bus routing controller select TDC0 from 4 TDCs, and output the data of P1 pixel from the TDC0; when T2 is 0010, the SPAD and the bus routing controller select TDC1 from the TDC and output the data of P2 pixel from the TDC1; When T3 is 0100, the SPAD and bus line routing controller selects TDC2 from TDC, and outputs data of P3 pixels from the TDC2; When T4 is 1000, the SPAD and bus line routing controller selects TDC3 from the TDC, and outputs data of P4 pixels from the TDC3.

It should be noted that, in the actual application scene, there are L groups of TDC units, and 1-L rows of pixels can be opened according to the actual application scene when rolling a single time, and the L rows of pixels cannot be opened at the same time.

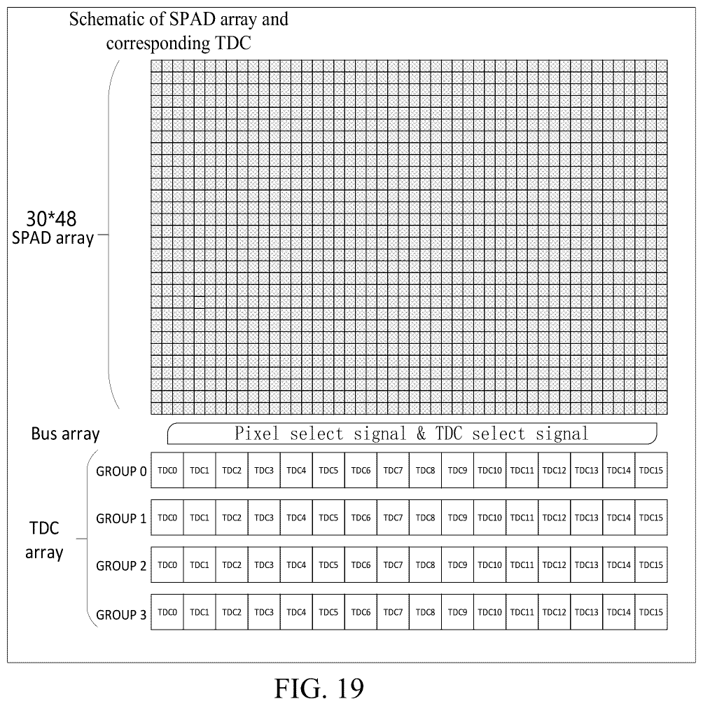

FIG. 19 is a schematic diagram of a 3*3 binning, 30*48 SPAD array supporting four rows of pixels at the same time and corresponding TDC according to an embodiment of the present invention. The flexible opening of the ROI area of the 30*48 SPAD array can be achieved by integrating the dynamic opening of the pixels in the horizontal direction and the dynamic multi-opening of the pixels in the vertical direction.

The laser distance-measuring receiving chip provided by the embodiment realizes the movement of the pixel in the vertical direction, namely the y-axis direction, and realizes the flexible opening of the SPAD ROI area.

It can be seen that, in the laser distance-measuring receiving chip provided in the embodiment of the invention, firstly, the light bar is divided into multiple segments of sub-light bars, each segment of sub-light bar can be independently configured with an open position, that is, the flexible configuration of SPAD is realized, so that according to the actual landing point of the light spot, configuring SPAD ROI area; and after the SPAD is turned on, the value of the signal can be selected according to the pixel, the value of the TDC selection signal controls the switch gating in the bus matrix, outputs the opened SPAD data, realizes the flexible opening of the SPAD ROI area, enables the RX to accurately receive the TX information, and realizes the distance measurement; secondly, the pixel can be dynamically opened in the horizontal direction and the pixel can be dynamically opened in the vertical direction, which realizes the flexible opening of the SPAD ROI area; thirdly, the flexible opening of the SPAD ROI area can reduce the requirements on the TX and RX processes and the precision of the assembly of the two devices, and greatly improve the yield of the product; In addition, under the condition that the SPAD array is small, the SPAD and TDC can be one-to-one correspondence, and in the invention, because there are pixel selection signals and TDC selection signals, under the condition that the SPAD array is large and the number of TDC is limited, The switch gating in the bus matrix can be controlled by the value of the pixel selection signal and the value of the TDC selection signal, so the SPAD signal is output by the corresponding TDC, the multiplexing of the TDC is realized, the number of the TDC is greatly reduced, and the cost is saved.

Based on the laser distance-measuring receiving chip described above, the embodiment of the invention further provides a configuration method of the laser ranging receiving chip in the calibration process in order to make the person in the technical field better understand the configuration information obtained in the solution of the invention. The configuration method of the laser distance-measuring receiving chip in the calibration process, using the configuration method of the laser distance-measuring receiving chip in the calibration process described above, comprises, obtaining the position of the light bar in the SPAD array, according to the position of the light bar and the preset precision, setting the number of the segments averagely divided by the light bar; according to the segment number of the light bar and the position of the light bar, configuring the position of the pixel where each segment of light bar is located.

The preset precision of the light bar divided into sub-light bars is not limited, and is determined according to the actual condition. In the implementation, in order to facilitate the configuration, when the light bar is equally divided into a plurality of sub-light bars, the number of pixels included in each sub-light bar in the horizontal direction is the same. Because the width of each segment of the sub-light bar is determined, the longitudinal coordinate of each segment of the sub-light bar is determined, therefore, when configuring the position of the sub-light bar, it only needs to configure the number of segments and the position of the longitudinal coordinate. As shown in FIG. 2, the light bar falls on the SPAD in which the first row of pixels in the SPAD array are located, and there are 288 SPAD in total, assuming that each segment of sub-light bar includes 36 SPAD as the preset precision, then the number of segments averagely divided by the light bar is set as 8 segments, namely seg0, seg1, seg2, . . . , seg7.

After obtaining each segment of sub-light bar, configuring the position of the pixel where each segment of sub-light bar is located. Because the opening position of each segment of sub-light bar is determined by the position coordinate of the left upper corner of each sub-light bar, the position of the pixel where each segment of sub-light bar is located is the position coordinate of the left upper corner of each pixel. Each segment of sub-light bar may be at the position of one pixel, or at the position where multiple pixels are. The position of the pixel where the sub-light bar is located is illustrated by taking the sub-light bar with the segment number of seg0 in FIG. 2 as an example, each small grid in FIG. 2 represents a pixel, the sub-light bar with the segment number of seg0 comprises four pixels, and the position coordinate of the left upper corner of the pixel of the first small grid from left to right is (0, 0); The position coordinates of the left upper corner of the pixel of the second cell are (3, 0), the position coordinates of the left upper corner of the pixel of the third cell are (6, 0), and the position coordinates of the left upper corner of the pixel of the fourth cell are (9, 0).

The above embodiment is configured according to the position of the pixel where each segment of sub-light bar is located, in order to accurately open the SPAD, after the position of the pixel where each segment of sub-light bar is located, the method further comprises, configuring the number of SPAD contained in one pixel, according to the position of the pixel of each segment of sub-light bar and the number of the SPAD contained in one pixel, configuring the position of each starting SPAD in the pixel of each segment of sub-light bar.

The number of SPAD included in each pixel of the configuration is not limited, and it is determined according to the actual situation, as in the embodiment, one pixel includes 3*3 SPAD, that is, one pixel includes 9 SPAD. after obtaining the position of the pixel where each segment of sub-light bar is located, combining the number of SPAD contained in one pixel, configuring the position of each starting SPAD in the pixel where each segment of sub-light bar is located. The position where each on SPAD is configured will be described below with reference to FIG. 2 and FIG. 3. Taking the sub-light bar with the segment number of seg0 in FIG. 2 as an example, it is assumed that the pixel A0, the pixel B0, the pixel C0, and the pixel C0 in the scene 1 in FIG. 3 are the same as the pixel A0, the pixel B0, the pixel C0, and the pixel C0 in the scene 1 in FIG. 3. The pixel DO corresponds to four pixels contained in the sub-light bar of seg0 in FIG. 2, and each small grid in FIG. 3 represents a SPAD, and the position coordinates of the pixel in which the sub-light bar with the segment number of seg0 is located are (0, 0), (3, 0), (6, 0), (9, 0), the position of each opened SPAD configured in the first pixel A0 is as follows: the position coordinates of the SPAD configured in the first row from left to right are (0, 0), (1, 0), (2, 0); the position coordinates of the SPAD arranged in the second row from left to right are (0, 1), (1, 1), (2, 1); The position coordinates of the SPAD arranged in the third row from the left to the right are (0, 2), (1, 2), (2, 2) in turn.

The method provided by the embodiment is configured with SPAD as unit, so that the SPAD can be accurately opened according to the configured position information of each opened SPAD.

When the SPAD in the SPAD array is less, the SPAD can be in one-to-one correspondence with the TDC unit, that is to say, the data of each SPAD can be output through the corresponding TDC unit, but when the SPAD array is large, if the SPAD is in one-to-one correspondence with the TDC unit, Therefore, in this embodiment, in order to reduce the cost, after configuring each position where the SPAD is opened in the pixel where each segment of sub-light bar is located, the method further comprises, the value of the pixel selection signal and the value of the TDC selection signal are configured such that each on-SPAD data can be output through the corresponding TDC unit.

With reference to FIG. 3 and FIG. 15, it is assumed that: The pixel selection signal is configured to be 001 so that TDC0 outputs data of pixel A (see FIG. 15, corresponding to data of SPAD with serial numbers of 0, 3, 6, 1, 4, 7, 2, 5, 8 in pixel A shown in FIG. 15); The pixel selection signal is configured to be 010 such that TDC0 outputs data of pixel A1 (see FIG. 15, corresponding to data of SPAD with serial numbers of 1, 4, 7, 2, 5, 8 in pixel A and 0, 3, 6 in pixel B shown in FIG. 15); The pixel selection signal is configured to be 100 so that TDC0 outputs data of pixel A2 (see FIG. 15, corresponding to data of SPAD with serial numbers of 2, 5, 8 in pixel A and 0, 3, 6, 1, 4, 7 in pixel B shown in FIG. 15). For TDC1 and TDC2, the same pixel selection signal as TDC0 may be used, or a different pixel selection signal may be used. The configuration can be more flexible when different pixel selection signals are used.

According to the value of the configuration information TDC selection signal, outputting the opened SPAD data through the corresponding TDC unit. The TDC selection signal is also configured in the configuration information so that the SPAD can be output through the selected TDC unit. Referring to FIG. 18, if the configured TDC selection signal T1 is 0001 for P1, the pixel P1 outputs data through TDC0; if the configured TDC selection signal T1 is 0010, the pixel P1 outputs data through TDC1; if the configured TDC selection signal T1 is 0100, the pixel P1 outputs data through TDC2; If the configured TDC selection signal T1 is 1000, the pixel P1 outputs data through the TDC3.

In the configuration method provided by the embodiment, by configuring the pixel selection signal and the TDC selection signal, one TDC unit can select the pixel to be output and one pixel can be output through the selected TDC unit.

When multiple rows of pixels need to be opened by scanning each time, the configuration method specifically comprises, configuring each scanning to open L rows of pixels; obtaining the position of L light bars in the SPAD array; according to the position and the preset precision of the L light bars, setting the average divided segment number of each light bar; according to the segment number of each light bar and the position of each light bar, configuring the position of the pixel where each sub-light bar is located.

The value of L is not limited, the shape of each light bar in the L light bars can be a straight line, a curve or an oblique line, and the different light bars can be adjacent or not adjacent. In FIG. 6, it is configured to open four rows of pixels at each time of scanning, that is, the value of L is 4, 4 light bars (light bar 0, light bar 1, the light bar 2 and the light bar 3) are located at the position of the SPAD array as shown in FIG. 6, and in FIG. 6, the light bar 0 and the light bar 1 are both curves, the light bar 2 and the light bar 3 are both straight lines, each light bar is set to be averagely divided into 8 segments, for the 8 segments of sub-light bars corresponding to the light bar 0, The positions of the first vertices of each sub-light bar from left to right are, in order, (0, 0), (12, 3), (24, 6), (36, 9), (48, 9), (60, 6), (72, 3), (84, 0); for the eight segments of sub-light bars corresponding to the light bar 1, the positions of the first vertex of each sub-light bar are configured from left to right in turn as follows: (0, 3), (12, 6), (24, 9), (36, 12), (48, 12), (60, 6), (72, 3), (84, 3); for the 8 segments of sub-light bars corresponding to the light bar 2, the positions of the first vertex of each sub-light bar are configured from left to right in turn as follows: (0, 15), (12, 15), (24, 15), (36, 15), (48, 15), (60, 15), (72, 15), (84, 15); for the 8 segments of sub-light bars corresponding to the light bar 3, the positions of the first vertex of each configuration sub-light bar from left to right are (0, 18), (12, 18), (24, 18), (36, 18), (48, 18), (60, 18), (72, 18), (84, 18), that is, the position of the pixel where each segment of sub-light bar is located is configured.

In order to support more accurate distance measurement under different ambient light intensities, the preferred embodiment is that, when it is necessary to control the amount of light entering, the configuration method further comprises: configuring the row number opened by SPAD in one pixel.

If one pixel contains N*N SPAD, the maximum value of the row number opened by SPAD in one pixel is N; Referring to FIG. 7, FIG. 8, FIG. 9 and FIG. 10, for example, a sub-light bar with a segment number of seg1 includes pixel 0, pixel 1, pixel 2 and pixel 3, and one row of SPAD in one pixel can be configured to be turned on (as shown in FIG. 10). 2 rows of SPAD are opened (as shown in FIG. 9) or 3 rows of SPAD are opened. The larger the number of lines opened by SPAD in a pixel is configured, the larger the incoming light amount is, which is suitable for measuring the distance of the laser distance-measuring receiving chip in the ambient with weak light, or the smaller the incoming light amount is, which is suitable for measuring the distance of the laser distance-measuring receiving chip in the ambient with strong light.

The method provided by the embodiment makes it possible to control the opening of the corresponding SPAD according to the configuration information by configuring the row number of the SPAD opening in one pixel, so as to support more accurate distance measurement in different environments by increasing/reducing the light inlet amount.

When the two-dimensional scanning is required each time, the position of the pixel where each segment of sub-light bar is located is configured, specifically comprising, configuring the segment number and row number of the sub-light bar corresponding to each light bar block; The light bar block comprises multiple segments of sub-light bars in the horizontal direction and multiple rows of sub-light bars in the vertical direction.

For the segment number of the sub-light bar corresponding to each light bar block, the row number is not limited, and is determined according to the actual condition. Taking the two-dimensional scanning in FIG. 14 as an example, the number of segments of the sub-light bars corresponding to each light bar block configured is 3 segments, 4 rows of pixels, and each light bar block comprises 3 segments of sub-light bars in the horizontal direction and 4 rows of light bars in the vertical direction. Specifically, the configuration information of the light bare block is the sub-light bare with the segment number of seg0, the sub-light bare with the segment number of seg1 and the sub-light bare with the segment number of seg2 in the horizontal direction, corresponding to the first row of pixels, the second row of pixels, the third row of pixels, a fourth row of pixels, the first row of pixels, the second row of pixels, the third row of pixels, and the fourth row of pixels corresponding to the sub-light bars having the segment numbers of seg0, seg1, seg2 in FIG. 14 are opened according to the configuration information during the first scanning; the configuration information of the light bar block is the sub-light bar with the segment number of seg2, the sub-light bar with the segment number of seg3 and the sub-light bar with the segment number of seg4 in the horizontal direction, corresponding to the second row of pixels, the third row of pixels, the fourth row of pixels, a fifth row of pixels, the second row of pixels, the third row of pixels, the fourth row of pixels, and the fifth row of pixels corresponding to the sub-light bars having the segment numbers of seg2, seg3, and seg4 in FIG. 14 are opened according to the configuration information during the second scanning; the configuration information of the light bar block is the sub-light bar with the segment number of seg4, the sub-light bar with the segment number of seg5 and the sub-light bar with the segment number of seg6 in the horizontal direction, corresponding to the fourth row of pixels, the fifth row of pixels, the sixth row of pixels, a seventh row of pixels, the fourth row of pixels, the fifth row of pixels, the sixth row of pixels, and the seventh row of pixels corresponding to the sub-light bars of seg4, seg5, seg6 in FIG. 14 are opened according to the configuration information during the third scanning.

In the method provided by the embodiment, by configuring the number of segments and the number of rows of the sub-light bars corresponding to each light bar block, the coverage of the larger field angle in the horizontal direction and the vertical direction can be realized according to the configuration information during the two-dimensional scanning.

The invention obtains the configuration information through the configuration method of the laser distance-measuring receiving chip in the calibration process, the configuration information is stored in the ROI configuration register in the laser ranging receiving chip, the SPAD and the bus routing controller can control the switch gating in the bus matrix according to the configuration information, The SPAD data is output through the corresponding TDC unit. The invention realizes the flexible opening of multiple pixels according to the actual position of the light bar, namely the flexible opening of the SPAD ROI area so that the RX end can completely detect the light bar to realize the measurement of the distance.

The laser distance-measuring receiving chip and the configuration method thereof in the calibration process provided by the present invention are described in detail above. The various embodiments in the specification are described in a progressive manner, and each of the embodiments is focused on the differences from the other embodiments, and the same similar portions between the various embodiments are referred to with each other. It should be noted that, for those skilled in the art, the present invention can be modified and modified without departing from the principle of the present invention, and these modifications and modifications are also within the protection scope of right for the present invention.

In various embodiments, a lid device is calibrated after manufacturing. The device features a bus matrix with multiple buses and switches, enabling flexible routing of signals between SPAD units and TDC units. Specifically, the bus matrix includes at least a first bus, a second bus, a first switch, and a second switch, allowing for disengageable connections between SPAD units and TDC units. The SPAD array comprises multiple SPAD units, while the TDC array consists of multiple TDC units, with the number of TDC units being fewer than the number of SPAD units. The design allows the first SPAD unit to be coupled to the first TDC unit via the first bus and first switch, and similarly, the second SPAD unit can be coupled to the second TDC unit. A notable feature of the bus matrix is its reconfigurability, which allows the first SPAD unit to be connected to the second TDC unit or other combinations, depending on operational needs. This reconfigurability also supports a calibration mode, where connections between SPAD and TDC units can be temporarily adjusted to fine-tune the device's performance with known light sources.

The device comprises a control mechanism that includes a register for storing configuration data, which indicates the connections between SPAD and TDC units. A controller is responsible for generating control signals to manage these connections. The controller can provide signals to switch the connections between different SPAD and TDC units, allowing the device to adapt dynamically during operation. Additionally, the switches within the bus matrix are implemented as multiplexers, enabling the selective coupling of any SPAD unit to any TDC unit. These multiplexers support the sequential coupling of multiple SPAD units to a single TDC unit, enhancing the flexibility of signal processing. Furthermore, the bus matrix supports simultaneous connections of multiple SPAD units to multiple TDC units, as well as the aggregation of signals from multiple SPAD units to a single TDC unit, which improves accuracy in low-light conditions.

It should also be noted that, in this specification, relational terms such as first and second, etc. are used to distinguish one entity or operation from another entity or operation, without necessarily requiring or implying any such actual relationship or order between these entities or operations. Furthermore, the terms “comprising”, “comprising” or any other variant thereof are intended to encompass non-exclusive inclusion, such that a process, method, or method comprising a series of elements is included. The article or device includes not only those elements, but also other elements that are not explicitly listed, or also elements inherent to such a process, method, article or device. Without further limitations, the elements defined by the statement “including one . . . ” are not excluded from the presence of additional identical elements in the process, method, article or device including the elements.

What is claimed is:

1. A device comprising:
a bus matrix comprising a plurality of buses and a plurality of switches, the plurality of buses comprising a first bus and a second bus, the plurality of switches comprising a first switch and a second switch;
a single-photon avalanche diode (SPAD) array, the SPAD array comprising a plurality of SPAD units, the plurality of SPAD units comprising a first SPAD unit and a second SPAD unit; and
a time-to-digital converter (TDC) array, the TDC array comprising a plurality of TDC units, the plurality of TDC units comprising a first TDC unit and a second TDC unit, wherein the number of TDC units is fewer than the number of SPAD units;
wherein:
the first SPAD unit is disengageably coupled to the first TDC unit via the first bus and the first switch;
the second SPAD unit is disengageably coupled to the second TDC unit via the second bus and the second switch;
the bus matrix is reconfigurable for connecting the first SPAD unit to the second TDC unit.

2. The device of claim 1, further comprising a register storing configuration for indicating a connection between the first SPAD unit and the first TDC unit.

3. The device of claim 2, further comprising a controller for providing a first control signal to cause the bus matrix to provide a connection between the first SPAD unit and the first TDC unit via the first bus and the first switch.

4. The device of claim 3, wherein the controller is configured to provide a second control signal for connecting the first SPAD unit to the second TDC unit.

5. The device of claim 1, wherein the first switch and the second switch are implemented as multiplexers, each configured to selectively couple any SPAD unit in the SPAD array to any TDC unit in the TDC array.

6. The device of claim 5, wherein the multiplexers are configured to allow multiple SPAD units to be coupled sequentially to the same TDC unit based on the control signals from the controller.

7. The device of claim 1, wherein the bus matrix is configured to support simultaneous connections of multiple SPAD units to multiple TDC units through parallel buses and switches.

8. The device of claim 1, wherein the bus matrix is further configured to allow the connection of multiple SPAD units to a single TDC unit to aggregate signals for improved accuracy in low-light conditions.

9. The device of claim 1, wherein the bus matrix is further configured to support a calibration mode in which the connections between SPAD units and TDC units are temporarily altered to calibrate the device's response to known light sources.

10. The device of claim 1, wherein SPAD units are grouped as pixels.

11. A method for configuring a laser distance-measuring device, the method comprising:
providing a single-photon avalanche diode (SPAD) array comprising SPAD units and a time-to-digital converter (TDC) array comprising TDC units, wherein a number of TDC units is fewer than a number of SPAD units;
configuring a bus matrix comprising a plurality of buses and a plurality of switches to connect the SPAD units to the TDC units;
storing configuration information in a region of interest (ROI) configuration register, the configuration information comprising a segmentation of the light bar into sub-light bars, the position of the pixel where each segment of the sub-light bar is located, the number of SPAD units in one pixel, the value of a pixel selection signal, and the value of a TDC selection signal;
setting the configuration information by the chip during a calibration process;
determining, using a SPAD and bus routing controller, the position where the SPAD units need to be opened based on the position of the pixel where each segment of the sub-light bar is located and the number of SPAD units in one pixel;
controlling the corresponding SPAD units to open based on the determined position;
transmitting the value of the pixel selection signal and the value of the TDC selection signal to the bus matrix to control the switch gating in the bus matrix;
outputting the opened SPAD data through the corresponding TDC unit.

12. The method of claim 11, further comprising storing position information of each SPAD unit contained in each pixel in the configuration information.

13. The method of claim 12, further comprising storing the segment number of each segment of the sub-light bar in the configuration information.

14. The method of claim 13, further comprising when multiple rows of light bars are obtained during the calibration process, storing the row number of the multiple rows of light bars in the configuration information.

15. The method of claim 11, further comprising storing the value of k in the configuration information, where k is an integer greater than or equal to 1 and less than or equal to N, one pixel comprises N×N SPAD units, and one pixel has k rows and N columns of SPAD units opened.

16. The method of claim 11, further comprising storing the segment number and row number of the sub-light bar corresponding to each light bar block in the configuration information, wherein the light bar block includes multiple segments of sub-light bars in the horizontal direction and multiple rows of sub-light bars in the vertical direction.

17. The method of claim 11, further comprising:
arranging each row in the SPAD array to comprise m SPAD units and each row in the TDC array to comprise m/N TDC units, with one TDC unit corresponding to one opened pixel, where m is greater than or equal to N, and one pixel comprises N×N SPAD units;
configuring the bus matrix to connect the SPAD units in the SPAD array with the TDC units in the TDC array through the plurality of switches, wherein the bus matrix connects one TDC unit in one row of TDC units with its corresponding pixel through the plurality of switches, and the plurality of pixels commonly connected with one TDC unit at least comprise one same column of SPAD units, and during one scan, only one opened pixel is output by the TDC unit.

18. The method of claim 17, further comprising controlling the switch gating in the bus matrix using the SPAD and bus routing controller, wherein one TDC unit in one row is connected with N pixels, and the SPAD and bus routing controller control the switch gating in the bus matrix according to the value of the pixel selection signal, selecting one opened pixel from N pixels, and outputting the data of the opened pixel from the TDC unit.

19. The method of any of claim 11, further comprising:
arranging one column of SPAD units in the SPAD array to comprise L pixels, and one column of TDC units in the TDC array to comprise L TDC units;
configuring the bus matrix to connect the SPAD units in the SPAD array with the TDC units in the TDC array, wherein the bus matrix connects any one pixel of L pixels in a column to any one TDC unit of L TDC units in a column.

20. The method of claim 19, further comprising controlling the switch gating in the bus matrix using the SPAD and bus routing controller, wherein a pixel in a column is connected with L TDC units, and the SPAD and bus routing controller control the switch gating in the bus matrix according to the value of the TDC selection signal, selecting one TDC unit from the L TDC units, and outputting the data of the pixel from the gated TDC unit.
